(19) United States
(12) Patent Application Publication
(10) Pub. No.: US 2009/0217319 A1
(43) Pub. Date: Aug. 27, 2009

(54) METHOD AND SYSTEM FOR PROVIDING TARGETED TELEVISION ADVERTISING

(76) Inventor: Jonathan B. WEISS, Allentown, PA (US)

Correspondence Address: MERCHANT & GOULD PC, P.O. BOX 2903, MINNEAPOLIS, MN, 55402-0903, US

(21) Appl. No.: 12/035,921

(22) Filed: Feb. 22, 2008

(51) Int. Cl. H04N 7/025; H04N 7/10; H04N 7/173

(52) U.S. Cl. 725/34; 725/32; 725/110; 705/14

(57) ABSTRACT

Method and system for providing a TV viewer with personal advertisements, includes a TV set connected to a television channels provider via a set-top box for displaying TV channels contents. The set-top box is connected to the television channels provider for receiving the television channels contents and enabling them to be displayed on said TV set. A computer is connected to the television channels provider via an adaptor, the computer is further connected to a data network enabling the TV viewer to search the data network by using one or more keywords. A personalized advertisements database stores personal advertisements to be presented to the TV viewer and to other TV viewers of the system. A viewers' queries database stores for each TV viewer his one or more keywords used when searching the data network. One or more software components for: managing the personalized advertisements database and the viewers' queries database; and providing to the TV viewer one or more personal advertisements within one or more time intervals allocated for advertising by the television channels provider. One or more personal advertisements are selected from the personalized advertisements database and related to his one or more keywords stored within the viewers' queries database.

### FIELD OF THE INVENTION

The present invention relates to television advertising. More particularly, the invention relates to a method and system for targeted television advertising, providing TV (television) viewers with personal advertisements, according to interests of each TV viewer. The particular field of the present invention is characterized as search marketing or interactive advertising.

### BACKGROUND OF THE INVENTION

A television advertisement or commercial is a form of advertising in which goods, services, organizations, ideas, etc. are promoted via the medium of television. Most commercials are produced by an outside advertising agency, and airtime is purchased from a television channel or network. Usually, television advertisements consist of advertising spots, ranging in length from a few seconds to several minutes, appearing between shows or shows segments. This advertising method has been used over the years to sell different products, from household products to goods and services to political campaigns. This method of screening advertisements is intended to capture the attention of the audience, keeping the viewers focused on the television show so that they may watch the advertisements while waiting for the next segment of the show.

Despite the success of some advertisements, many are shown to uninterested viewers, who are not currently in the market for these goods and services (e.g., the advertisements can be displayed according to surveys done by companies which compile data on ratings, and are based on probability that they have a better chance to reach the interested viewer who may purchase the product or service being advertised).

US 2006/0074769 presents a personalized marketing architecture that uses real-time data and explicit customer input to augment marketing segmentation, analysis and video advertisement delivery. Customer behavior, preferences and intentions are monitored and identified to present real-time video messages. Real-time data may be collected based on the customer's data access permission profile to provide messages on an in-home personal portal or on out-of-home display devices to provide personalized messages in public spaces. Another patent application, US 2002/0035573, discloses a system for displaying products or services for purchase on any document displayed on any computer device, comprising conducting a statistical frequency analysis of the word occurrence in the document to determine the primary subject matter of the document and/or keywords in the document, and selecting products which are relevant to the subject matter and keywords of the document. However, neither US 2006/0074769 nor US 2002/0035573 teaches providing personalized TV advertisements.

US 2006/0031405 presents systems and methods for selecting and inserting advertisements in an information document displayed to a user, wherein the selection is based at least in part on television programming viewed by the user. The systems and methods may be implemented using the Internet or another information retrieval system that includes a client system and a remote server. The client system monitors television programming viewed by the user and compiles a user profile characterizing the television programming. When the user requests an Internet resource using the client system, the television programming information in the user profile is utilized to select an appropriate advertisement. The advertisement is then inserted in the information document and displayed to the user. US 2006/0277569 discloses DVR-based (Digital Video Recorder) targeted advertising. A targeted advertisement system includes a DVR, an advertisement data store, and an advertisement manager. The DVR records media content, maintains the recorded media content for on-demand viewing, and provides the recorded media content for viewing when requested. The advertisement manager designates advertisement region(s) in the recorded media content as the media content is being recorded, where an advertisement region includes a first boundary and a second boundary to designate the advertisement region in the media content. However, neither US 2006/0031405 nor US 2006/0277569 teach providing personalized TV advertisements, according to users search queries which were used when searching the Web.

Therefore, there is an on-going need to provide TV viewers with personalized TV advertisements, according to interests of each viewer.

It is an object of the present invention to provide a method and system for targeted television advertising, providing TV viewers with personal advertisements.

It is still another object of the present invention to provide a method and system for providing television advertisements to a plurality of TV viewers, wherein products and/or services of each advertisement offer are relevant to the corresponding TV viewer or household at least at the time of their presentation.

It is a further object of the present invention to provide a method and system, which is user friendly and accessible to any advertiser wishing to create an advertisement.

It is still a further object of the present invention to provide a method and system, which secures personal information and does not invade the privacy of viewers and households.

It is still a further object of the present invention to provide a method and system, which transforms the current “one-dimensional” advertising space available in a time slot between shows or show segments into an unlimited number of available advertising spaces for a plurality of TV viewers.

It is still a further object of the present invention to provide a method and system for automated targeted advertising, enabling advertisers to directly access TV viewers without using services of an external (3-rd party) companies.

It is still a further object of the present invention to provide a method and system, which is more cost-effective relative to the prior art.

Other objects and advantages of the invention will become apparent as the description proceeds.

### SUMMARY OF THE INVENTION

The present invention relates to a method and system for targeted television advertising, providing TV viewers with personal (targeted) advertisements, according to the interests of each viewer. Particularly, the present invention relates to search marketing and interactive advertising.

The system for providing a TV viewer with personal advertisements comprises: (a.) a TV set connected to a television channels provider via a set-top box for displaying TV channels contents, said set-top box connected to said television channels provider for receiving the television channels contents and enabling them to be displayed on said TV set; (b.) a computer connected to said television channels provider via an adaptor, said computer further connected to a data network enabling said TV viewer to search said data network by using one or more keywords; (c.) a personalized advertisements database for storing a plurality of personal advertisements to be presented to said TV viewer and to other TV viewers of said system; (d.) a viewers' queries database for storing for each TV viewer his one or more keywords used when searching said data network; and (e.) one or more software components provided by said television channels provider for: (e.1.) managing said personalized advertisements database and said viewers' queries database; and (e.2.) providing to said TV viewer one or more personal advertisements within one or more time intervals allocated for advertising by means of said television channels provider, said one or more personal advertisements being selected from said personalized advertisements database and being related to his said one or more keywords stored within said viewers' queries database.

According to a preferred embodiment of the present invention, the adaptor is integrated within the set-top box.

According to another preferred embodiment of the present invention, the personal computer is integrated within the set-top box.

According to a preferred embodiment of the present invention, the set-top box has a unique readable serial number for enabling the television channels provider to identify it within a plurality of set-top boxes and provide to it personal advertisements.

According to another preferred embodiment of the present invention, the adaptor has a unique readable serial number for enabling the television channels provider to identify it within a plurality of adaptors and provide to it personal advertisements.

According to still another preferred embodiment of the present invention, the computer further comprises a software component that determines the one or more keywords used by the TV viewer when searching the data network, and sends them for storage to said viewers' queries database via the adaptor.

According to a particular preferred embodiment of the present invention, the memory space for storing the one or more keywords of each TV viewer is dynamically allocated within the viewers' queries database.

The method for providing a TV viewer with personal advertisements comprises: (a.) providing a TV set connected to a television channels provider via a set-top box for displaying TV channels contents; (b.) receiving the television channels contents and enabling them to be displayed on said TV set by means of said set-top box connected to said television channels provider; (c.) enabling said TV viewer to search a data network by using one or more keywords by means of a computer connected to said data network, said computer further connected to said television channels provider via an adaptor; (d.) storing within a personalized advertisements database a plurality of personal advertisements to be presented to said TV viewer and to other TV viewers of said system; (e.) storing for each TV viewer, within a viewers' queries database, his one or more keywords used when searching said data network; and (f.) providing one or more software components that are further provided by said television channels provider for: (f.1.) managing said personalized advertisements database and said viewers' queries database; and (f.2.) providing to said TV viewer one or more personal advertisements within one or more time intervals allocated for advertising by means of said television channels provider, said one or more personal advertisements being selected from said personalized advertisements database and being related to his said one or more keywords stored within said viewers' queries database.

### BRIEF DESCRIPTION OF THE DRAWINGS

In the drawings:

FIG. 1 illustrates a conventional system for providing TV programs and TV advertisements to a plurality of TV viewers, according to the prior art;

FIG. 2A illustrates a system for providing TV programs and personalized (targeted) TV advertisements to a plurality of TV viewers by using an adaptor, according to a preferred embodiment of the present invention;

FIG. 2B illustrates a system for providing TV programs and personalized (targeted) TV advertisements to a plurality of TV viewers without utilizing an adaptor, according to another preferred embodiment of the present invention;

FIG. 3A is a schematic illustration of an adaptor, according to a preferred embodiment of the present invention;

FIG. 3B is a schematic illustration of providing personal TV advertisements to each TV viewer by using an adaptor, according to a preferred embodiment of the present invention; and

FIG. 3C is a schematic illustration of providing personal TV advertisements to each TV viewer without utilizing an adaptor, according to another preferred embodiment of the present invention.

### DETAILED DESCRIPTION OF THE PREFERRED EMBODIMENTS

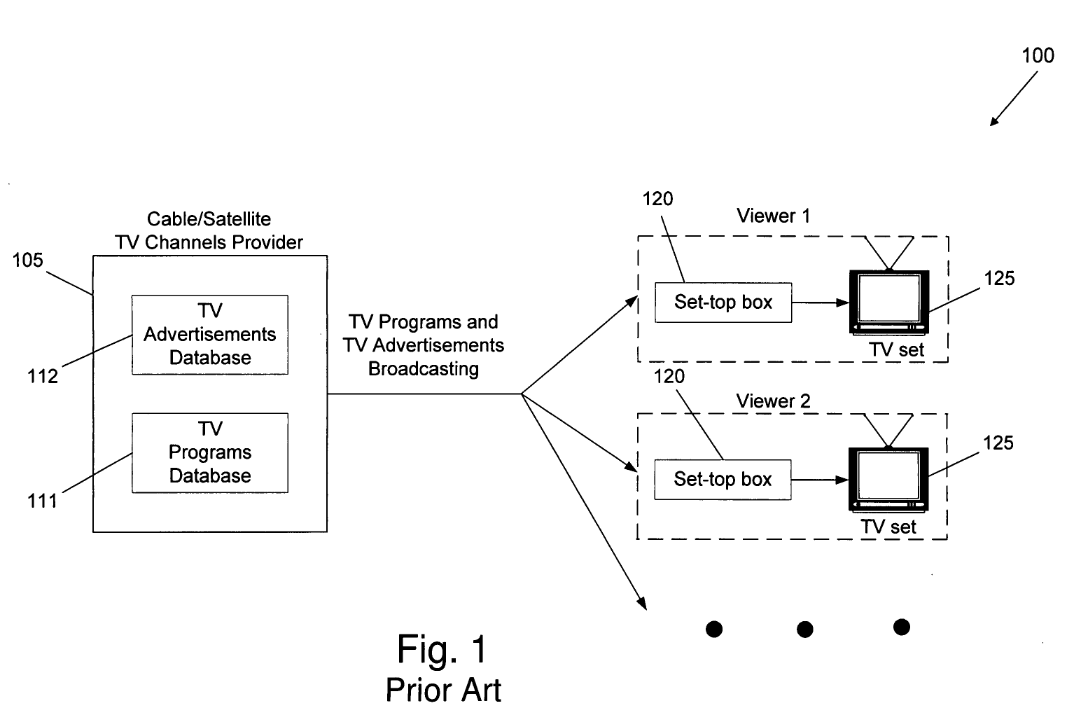

FIG. 1A illustrates a conventional system 100 for providing TV programs and TV advertisements to a plurality of TV viewers, according to the prior art. The system comprises a Cable/Satellite TV Channels Provider 105 for broadcasting various TV contents (e.g., TV programs and TV advertisements) to a plurality of TV viewers; a plurality of Set-top boxes 120 for receiving and decoding said TV contents, while the one or more Set-top boxes 120 belong to the same TV viewer; and a plurality of TV sets, each connected to corresponding Set-top box 120 for presenting the decoded TV contents to said TV viewers.

Cable/Satellite TV Channels Provider 105 comprises a database 111 of TV programs to be broadcasted to a plurality of TV viewers (such as Viewer 1, Viewer 2, etc.), and a database 112 of TV advertisements, wherein one or more advertisements are presented to said TV viewers in time intervals between presenting said TV programs or portions (segments) of said TV programs. TV contents are usually broadcasted to a plurality of TV viewers by means of cables or by means of a satellite. Each TV viewer, such as Viewer 1 and Viewer 2 can receive the broadcasted TV contents by means of an antenna, from which they are transferred to Set-top box 120 that decodes these TV contents, and then the decoded TV contents are displayed on viewer's TV set. According to the prior art, all TV viewers watch exactly the same TV contents (TV programs, advertisements, etc), although these contents are not relevant to all TV viewers. Therefore, TV viewers usually use a TV program guide to decide which program they wish to watch. Also, when watching local channels, the TV viewers are provided only with advertisements of their country of residence (e.g., United States, Canada). TV viewers cannot choose which TV advertisements they would like to watch and which not, and thus they have no control over the TV advertisements. TV advertisements are usually treated as a time for a break between program (show) segments since said TV viewers are not interested in watching them due to their irrelevance (at least at the moment of their presentation). According to the prier art, the advertisements are displayed according to surveys done by TV advertisements rating companies (such as “The Nielsen Company” located in United States) that track the television habits of TV viewers. The advertisements presentation is based on the probability that they have a better chance to reach the interested viewers who may purchase the product or service being advertised.

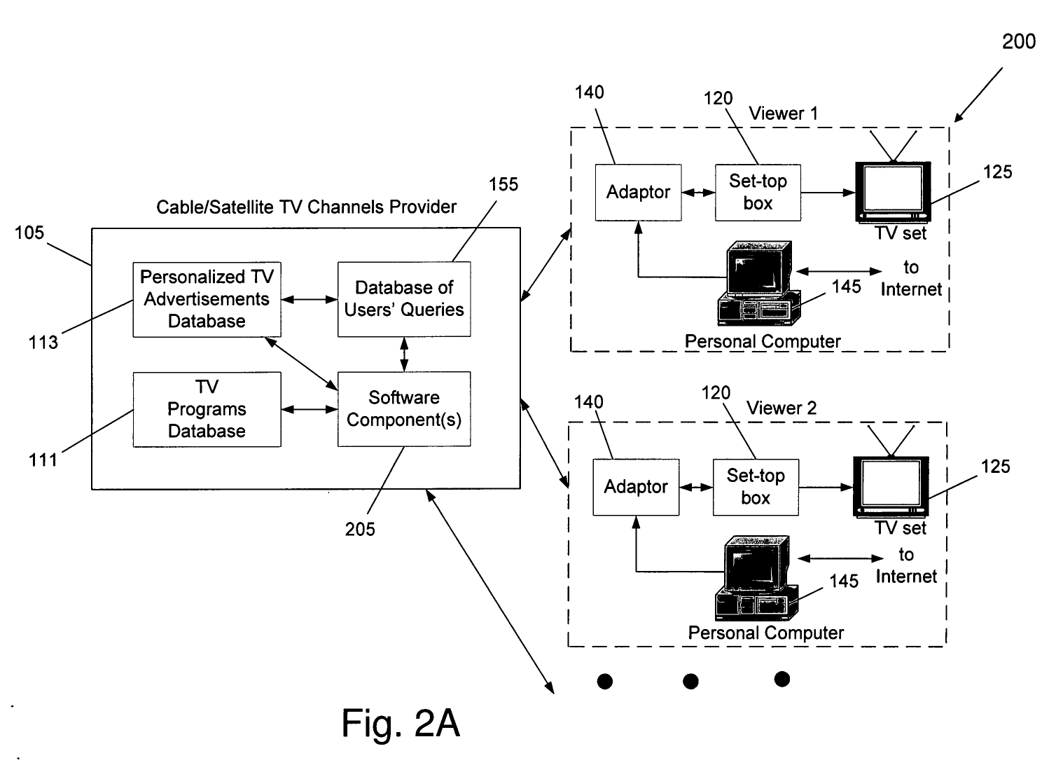

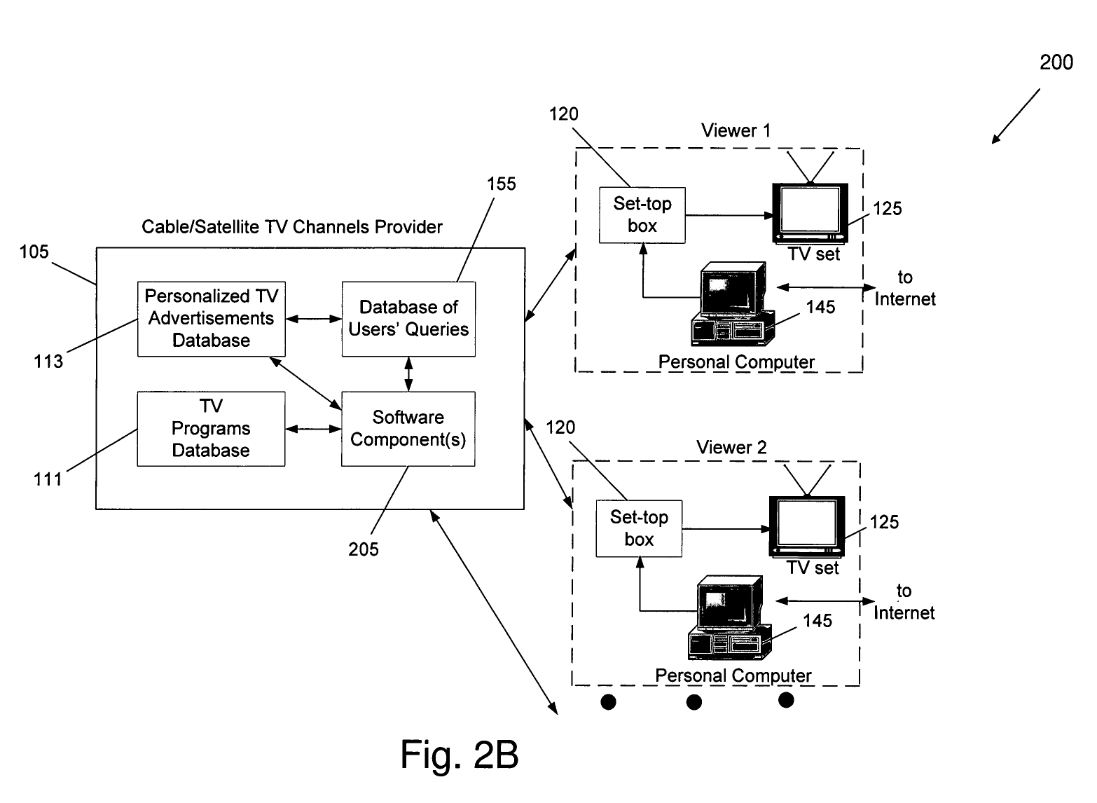

FIG. 2A illustrates a system 200 for providing TV programs and personalized (targeted) TV advertisements to a plurality of TV viewers by using Adaptor 140, according to a preferred embodiment of the present invention. The system comprises a Cable/Satellite TV Channels Provider (server) 105 for broadcasting TV contents (such as TV programs and personalized TV advertisements) to a plurality of TV viewers, said TV Channels Provider 105 comprising a Personalized TV Advertisements Database 113 for storing targeted (personal) TV advertisements, a TV Programs Database 111 for storing TV programs, a Database 155 of users' (viewers') search queries conducted over a data network (such as the Internet), and a Software Component(s) 205 for managing said databases; a plurality of Adaptors 140 connected to Personal Computers 145 and to said TV Channels Provider 105 for interconnecting each Personal Computer 145 with said TV Channels Provider 105; a plurality of Personal Computers 145 connected to the data network and to Adaptors 140 that interconnect them with TV Channels Provider 105, wherein a dedicated software component is installed within each Personal Computer 145 for: determining keywords (queries) that the viewer has used when searching the Web; and for sending these keywords for storage (within Database 155 of users' search queries) to said TV Channels Provider 105 via the corresponding Adaptor 140; a plurality of Set-top boxes 120, each connected to its corresponding Adaptor, for decoding the received TV contents; and a plurality of TV sets, each connected to the corresponding Set-top box 120 for presenting the decoded TV contents (with personal advertisements) to said TV viewers.

Each viewer (such as Viewer 1 and Viewer 2) surfs the Internet by means of his Personal Computer 145 using his conventional Internet Browser (e.g., Microsoft® Internet Explorer). Usually, for finding various information over the Internet, the user (viewer) uses one or more conventional search engines, such as Google™, Yahoo®, MSN®, etc. When searching the Web by means of such search engines, the user enters his search query (one or more corresponding keywords) into the corresponding text field within a search engine Web page. Then, he is presented with corresponding one or more search results related to his query. According to a preferred embodiment of the present invention, the above keywords (user's query) are determined by means of a software component installed within Personal Computer 145, and then they are transferred (sent) to Cable/Satellite TV Channels Provider 105 via Adaptor 140, which is connected to said Personal Computer 145 and TV Channels Provider 105 either by means of a wire or wireless connection. In turn, said TV Channels Provider (server) 105 provides advertisements from its Personalized TV Advertisements Database 113 (TV advertisements platform) according to the received user's keywords, phrases, categories, filters, and other defining information, insuring by this way that the selected advertisements will be within user's field of interests, and thus, will not be ignored by the user. Then, the advertisements are presented to the user on his television screen.

Personalized TV Advertisements Database 113 (platform) is keyword, key-phrase and category-based. According to a preferred embodiment of the present invention, the advertisements are presented to the TV viewers on a Cost Per View (CPV) basis or on another predefined cost basis. For each advertisement presented to one or more TV viewers or households, each advertiser pays a predefined sum of money. Personalized TV Advertisements Database 113 is managed by means of Software component 205 that decides by using a specific algorithm which advertisement should be displayed first, which should be displayed second, etc. The algorithm considers the duration of a corresponding time interval (space), that is allocated for advertising by means of the Cable/Satellite TV Channels Provider 105 between shows or shows segments, for fitting into it one or more targeted (personal) advertisements for each TV viewer.

According to a preferred embodiment of the present invention, each Adaptor 140 and/or Set-top box 120 can have a unique readable serial number in order to enable TV Channels Provider 105 to identify said Set-top box 120 and/or Adaptor 140 within a plurality of Set-top boxes 120 and/or Adaptors 140 (that belong to a plurality of TV viewers), and to send them corresponding personal advertisements. The unique serial number can be encrypted and scrambled, changing its actual numerical form in order to protect the privacy of the corresponding TV viewer. For example, if the unique serial number of corresponding Set-top box 120 is 6097823942309 (13 digits), then each time before establishing communication with Personalized TV Advertisements Database 113 and/or Database 155 of users search queries, the number can be first scrambled—7906293894203, and then encrypted—ZX00028XXUILP by using a unique encryption key. The scrambled numbers can be dumped immediately following their use and may be re-used later in order to make sure that no number is used only once network-wide. By this way, tracking or identification in any way can be prevented, and each encryption code can be used by a plurality of TV viewers, each separately and at different times and dates.

It should be noted that in addition to determining keywords that the user has used when searching the Internet, the software component installed within said Personal Computer 145 can further determine user's general behavior over the Internet, such as detecting which Internet sites the user usually surfs and what products the user usually purchase online, and then determining user's field of interests accordingly. Then, this data (and other users' behavioral data) are sent to Software component 205 (and/or Database 155 of Users' Queries) that decides by using a specific algorithm which advertisement from Personalized TV Advertisements Database 113 should be displayed first, which should be displayed second, etc. The algorithm considers the duration of a corresponding time interval (space), that is allocated for advertising by means of the Cable/Satellite TV Channels Provider 105 between shows or shows segments, for fitting into it one or more targeted (personal) advertisements for each TV viewer.

Adaptor 140 is further connected to conventional Set-top box 120, interconnecting TV set 125 and Personal Computer 145 with TV Channels Provider (server) 105, and as a result, enabling TV users to be presented with targeted advertisements according to their interests that in turn are determined according to their Web activities (e.g., searching the Internet by using one or more keywords). Thus, the TV viewer is provided with relevant TV advertisements, that is beneficial to both said TV viewer and a TV advertiser: the TV viewer is presented with advertisements in which he is interested, and the TV advertiser can pay less money for his advertisements, since he can pay only for displaying his advertisements to the relevant TV viewers and not to all existing TV viewers. The reduction in cost significantly increases the amount of advertisers being able to advertise by means of television, and as a result, revenues of Cable/Satellite TV Channels Provider 105 are also increased.

Cable/Satellite TV Channels Provider 105 can further comprise a Database 155 of users' search queries over the Internet. By analyzing the queries of each user and determining his field of interests, Software Component(s) 205 determines (by using corresponding algorithm(s)) what advertisements should be selected from Personalized TV Advertisements Database 113 and presented to said each user in order to be relevant to him. In addition, Software Component 205 decides (by using a specific algorithm) about the order of the advertisements presentation and their repetition (each advertisement can be presented to a corresponding TV viewer one or more time). For example, if the user's search queries are: banks, stocks, investments and the like, then the TV advertisements of banks and investments companies can be presented to him. Also, if the user is mainly interested in banks (he is mainly searches the Web by using the keyword “bank”, then the bank advertisements can be presented to him first, and after that advertisements related to investments companies. This can be determined according to the one or more of the following: 1) advertiser's preferences; 2) Cable/Satellite TV Channels Provider 105 preferences; 3) each TV viewer personal settings, limitations, filters, etc.

For each TV viewer, a predefined memory space can be allocated within said Database 155 for storing his search queries. The allocated memory space can be dynamically increased or decreased according to user's Internet activities: if the user performs many searches over the Internet and/or surfs many Web sites, then for such user more memory space is allocated. According to a preferred embodiment of the present invention, after the advertisement has been presented to the user, it can be further presented to said user a predefined number of times or not presented at all, according to definitions and settings of each advertiser. For example, the advertiser can define that for Brazil residents each advertisement related to sport shoes and sport clothes is presented three times a day, and for United States residents only once a day. Further, the advertiser can select specific hours of a day/night, in which his advertisement will be presented; he can decide that his advertisement will be presented to TV viewers living in a specific location, such as a specific country, region, city, zip code, etc.; he can decide that his advertisement will be presented to TV viewers that speak specific language (English, Spanish, Russian, etc.).

According to another preferred embodiment of the present invention, Adaptor 140 is wirelessly connected to Set-top box 120 and/or Personal Computer 145. For that, said Adaptor 140, Set-top box 120 and/or Personal Computer 145 (e.g., a laptop) can have corresponding wireless connection communication units/components.

According to still another preferred embodiment of the present invention, Adaptor 140 is attached to Set-top box 120, interconnecting TV set 125 and Personal Computer 145 with TV Channels Provider (server) 105.

It should be noted that Adaptor 140 can be further connected to the power supply of Set-top box 120 and/or to an external power supply for providing electrical power to all its electronics units and components.

Also, it should be further noted that according to another preferred embodiment of the present invention, either Personalized TV Advertisements Database 113 or Viewers' Queries Database 155 can be located within a 3-rd party server and not within server 105 the Cable/Satellite TV Channels Provider.

FIG. 2B illustrates a system 200 for providing TV programs and personalized (targeted) TV advertisements to a plurality of TV viewers without utilizing an adaptor, according to another preferred embodiment of the present invention. According to this preferred embodiment, Adaptor 140 is integrated into Set-top box 120 and is a part of it, interconnecting TV set 125 and Personal Computer 145 with TV Channels Provider (server) 105. Thus, the TV viewer does not need to acquire any additional hardware (such as said Adaptor 140) in order to implement the method and system of the present invention. Set-top box 120 can be, for example, of “DCT6200/DCT6208” model developed by Motorola Inc.

According to still another preferred embodiment of the present invention, Set-top box 120 is wirelessly connected to Personal Computer 145. For that, said Set-top box 120 and Personal Computer 145 (e.g., a laptop) can have corresponding wireless connection communication units/components.

It should be noted that according to still another preferred embodiment of the present invention, Personal Computer 145 can be also integrated into Set-top box 120, enabling each TV viewer to surf the Web by using his TV screen. Such Set-top box 120 can be, for example, of “STB2300” model developed by Tatung Co. located in Taiwan.

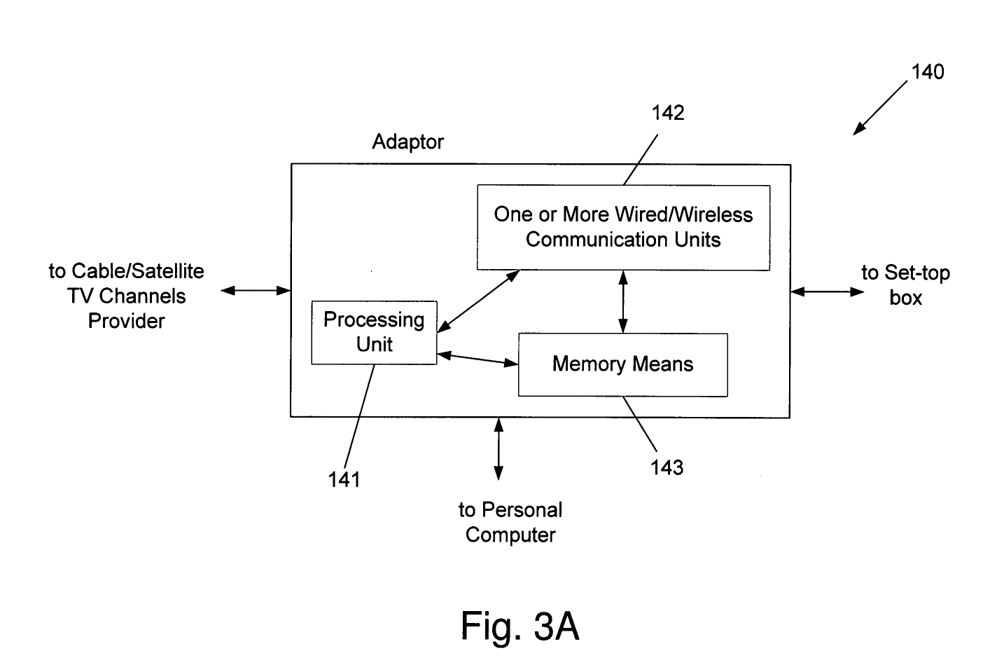

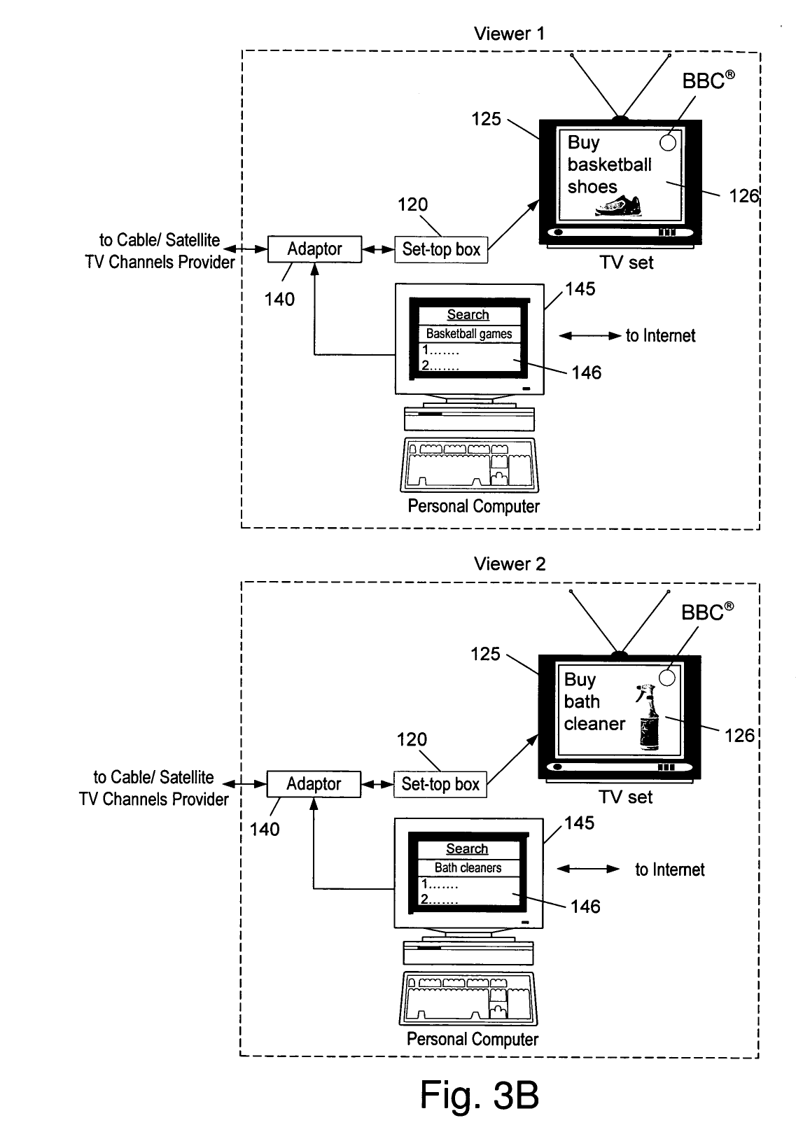

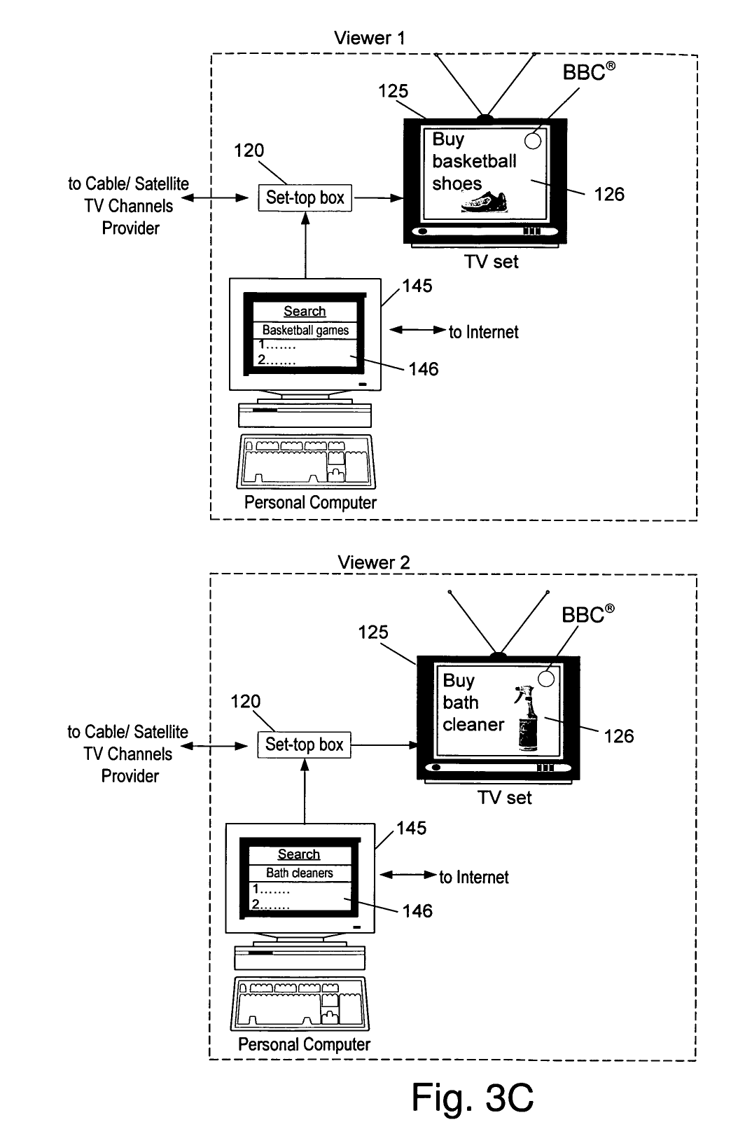

FIG. 3A is a schematic illustration of an Adaptor 140, according to a preferred embodiment of the present invention. Adaptor 140 has a number of Inputs/Outputs, such as: 1) to and from Cable/Satellite TV Channels Provider 105; 2) to and from Personal Computer 145; and 3) to and from Set-top box 120. Adaptor 140 can comprise a processing unit 141 for processing data, and one or more wired/wireless communication units for communicating with TV Channels Provider 105, Set-top box 120 and Personal Computer 145; and memory means for storing the processed data (if required).

According to another preferred embodiment of the present invention, Adaptor 140 is directly connected to a data network, such as the Internet, and for that it has a corresponding Inputs/Output.

FIG. 3B is a schematic illustration of providing personal TV advertisements to each TV viewer (such as Viewer 1 and Viewer 2) by using Adaptor 140, according to a preferred embodiment of the present invention. It is demonstrated that Viewer 1 surfs the Internet and searches for basketball games, and Viewer 2 searches for bath cleaners. The search keywords “basketball games” and “bath cleaners” are determined by means of a dedicated software component installed within each user's Personal Computer 145, and then they are sent to Cable/Satellite TV Channels Provider 105 (FIG. 2) via corresponding Adaptor 140. It should be noted that if Adaptor 140 is connected to said TV Channels Provider 105 by means of cables, then the keywords can be sent via said Adaptor 140 to said TV Channels Provider 105 over said cables. On the other hand, if Adaptor 140 receives TV contents from said TV Channels Provider 105 by means of a satellite, then Adaptor 140 can be further connected to TV Channels Provider 105 by means of a conventional telephone line for transferring the keywords to said TV Channels Provider 105. After TV Channels Provider 105 receives the keywords, it selects one or more corresponding advertisements from its Personalized TV Advertisements Database 113 (FIG. 2). Then, the selected advertisements are received by means of each Set-top box 120 through said corresponding Adaptor 140. Finally, as shown on FIG. 3B, Viewer 1 (when watching, for example, the BBC® television channel) can be presented with an advertisement of basketball shoes, for example, of Nike® or of any other advertiser. Similarly, Viewer 2 can be presented with an advertisement of a bath cleaner, when watching said BBC® television channel.

It should be noted that each advertiser can design and define his advertisement online by surfing to TV Channels Provider 105 home page, creating a personal account and logging into it. When the advertiser is logged in into his account, he can be presented with a comprehensive user interface, in which he can: design and edit his TV advertisement by means of a corresponding software component; upload one or more files (e.g., images, pictures, video clips, textual data, etc.); define for which one or more keywords, key-phrases, categories, and other settings (such as TV viewers geographic location, etc.), his advertisement would be presented to one or more TV viewers; set the language of his advertisement; record a voice file to be played during displaying his advertisement. In addition, the advertiser can place a bid for displaying his advertisement at a specific time (e.g., on January 10, at 10.00 PM), according to one or more predefined keywords for which the advertiser wishes his advertisement to be displayed, and then the advertisement for which the greatest bid (for example, related to the cost per view (CPV) and/or other predefined costs) was placed is displayed at said specific time with (optionally) any additional data (e.g., advertisement duration, etc.). Also, the TV advertising can be targeted to a specific location, such as to specific country, region, city, zip code and the like, enabling the advertiser to designate his advertisement only to that location. The advertiser can further select a time period and frequency with which his advertisement will be displayed. For example, he can define that his advertisement will be displayed every day between 18.00 to 20.00 (in the time intervals between TV programs and/or between segments of said TV programs allotted by the TV Channels Provider).

According to a preferred embodiment of the present invention, TV Channels Provider 105 receives from a plurality of advertisers their TV advertisements to be presented to TV viewers for their corresponding search queries (keywords), and displays them according to advertisers' settings: time period, display frequency (e.g., per each user IP (Internet Protocol) address, per 24-hour period, etc.), bids, etc. In addition, TV Channels Provider 105 or any 3rd party company/person can design and prepare TV advertisements for advertisers, according to advertisers' settings and definitions. The advertiser can see at any time, by logging into his personal account, various statistical data related to his advertisement. For example, he can see how many times his advertisement was displayed, how much it cost him, and any other billing information. In addition, he can set the maximum limit of his expenses per day, week, month, etc., or temporarily or permanently deactivate his TV advertisement.

FIG. 3C is a schematic illustration of providing personal TV advertisements to each TV viewer without utilizing an adaptor, according to another preferred embodiment of the present invention. According to this preferred embodiment, Adaptor 140 is integrated into Set-top box 120 and is a part of it, interconnecting TV set 125 and Personal Computer 145 with TV Channels Provider 105. Thus, the TV viewer does not need to acquire any additional hardware (such as said Adaptor 140) in order to implement the method and system of the present invention.

It should be noted that according to a preferred embodiment of the present invention, the keywords that are stored within Search Queries Database 155 more than a predefined period of time (e.g., a month) and that are no more used by TV viewers when searching a data network (such as the Internet) can be deleted. According to another preferred embodiment of the present invention, when presenting personal advertisements to a plurality of TV viewers, such keywords can not be considered.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for providing a TV viewer with personal advertisements, comprising:
a. a TV set connected to a television channels provider via a set-top box for displaying TV channels contents, said set-top box connected to said television channels provider for receiving the television channels contents and enabling them to be displayed on said TV set;
b. a computer connected to said television channels provider via an adaptor, said computer further connected to a data network enabling said TV viewer to search said data network by using one or more keywords;
c. a personalized advertisements database for storing a plurality of personal advertisements to be presented to said TV viewer and to other TV viewers of said system;
d. a viewers' queries database for storing for each TV viewer his one or more keywords used when searching said data network; and
e. one or more software components provided by said television channels provider for:
e.1. managing said personalized advertisements database and said viewers' queries database; and
e.2. providing to said TV viewer one or more personal advertisements within one or more time intervals allocated for advertising by means of said television channels provider, said one or more personal advertisements being selected from said personalized advertisements database and being related to his said one or more keywords stored within said viewers' queries database.

2. System according to claim 1, wherein the adaptor is integrated within the set-top box.

3. System according to claim 1, wherein the personal computer is integrated within the set-top box.

4. System according to claim 1, wherein the set-top box has a unique readable serial number for enabling the television channels provider to identify it within a plurality of set-top boxes and provide to it personal advertisements.

5. System according to claim 1, wherein the adaptor has a unique readable serial number for enabling the television channels provider to identify it within a plurality of adaptors and provide to it personal advertisements.

6. System according to claim 1, wherein the computer further comprises a software component that determines the one or more keywords used by the TV viewer when searching the data network, and sends them for storage to said viewers' queries database over said data network.

7. System according to claim 1, wherein the memory space for storing the one or more keywords of each TV viewer is dynamically allocated within the viewers' queries database.

8. System according to claim 1, wherein the adaptor is wirelessly connected to the set-top box and/or computer.

9. A method for providing a TV viewer with personal advertisements, comprising:
a. providing a TV set connected to a television channels provider via a set-top box for displaying TV channels contents;
b. receiving the television channels contents and enabling them to be displayed on said TV set by means of said set-top box connected to said television channels provider;
c. enabling said TV viewer to search a data network by using one or more keywords by means of a computer connected to said data network, said computer further connected to said television channels provider via an adaptor;
d. storing within a personalized advertisements database a plurality of personal advertisements to be presented to said TV viewer and to other TV viewers of said system;
e. storing for each TV viewer, within a viewers' queries database, the one or more keywords used when searching said data network; and
f. providing one or more software components that are further provided by said television channels provider for:
f.1. managing said personalized advertisements database and said viewers' queries database; and
f.2. providing to said TV viewer one or more personal advertisements within one or more time intervals allocated for advertising by means of said television channels provider, said one or more personal advertisements being selected from said personalized advertisements database and being related to his said one or more keywords stored within said viewers' queries database.

10. Method according to claim 9, further comprising integrating the adaptor within the set-top box.

11. Method according to claim 9, further comprising integrating the personal computer within the set-top box.

12. Method according to claim 9, further comprising providing the set-top box with a unique readable serial number for enabling the television channels provider to identify it within a plurality of set-top boxes and provide to it personal advertisements.

13. Method according to claim 9, further comprising providing the adaptor with a unique readable serial number for enabling the television channels provider to identify it within a plurality of adaptors and provide to it personal advertisements.

14. Method according to claim 9, further comprising installing within the computer a software component for determining the one or more keywords used by the TV viewer when searching the data network, and for sending them for storage to said viewers' queries over said data network.

15. Method according to claim 9, further comprising dynamically allocating within the viewers' queries database the memory space for storing the one or more keywords of each TV viewer.

16. Method according to claim 9, further comprising wirelessly connecting the adaptor to the set-top box and/or computer.
